(19) United States
(12) Patent Application Publication
(10) Pub. No.: US 2009/0298031 A1
(43) Pub. Date: Dec. 3, 2009

(54) Hyperbilirubinemia management calendar

(76) Inventor: Bedford Nieves-Cruz, Houma, LA (US)

Correspondence Address: JUAN J. LIZARRAGA, 909 POYDRAS STREET, SUITE 2300, NEW ORLEANS, LA, 70112-1010, US

(21) Appl. No.: 12/156,069

(22) Filed: May 29, 2008

(51) Int. Cl. G09B 23/28

(52) U.S. Cl. 434/262

(57) ABSTRACT

A hyperbilirubinemia management calendar for use by treating physicians and associated caregivers in treatment of hyperbilirubinemia in newborn infants having a first circular disc imprinted with indicia corresponding to postnatal age in hours and threshold serum levels of bilirubin based on risk levels and risk factors for phototherapy, exchange transfusion and follow up treatment therapies at each of the age in hour increments, and a second circular disc, subdivided into portions representing the phototherapy, exchange transfusion, and follow up stages of hyperbilirubinemia management, with each portion having corresponding indicia for risk levels and risk factors as well as windows to allow view of the threshold serum bilirubin levels imprinted on the first disc pertaining to a selected postnatal age in hours for a certain risk level and risk factor for each hyperbilirubinemia management stage. The second disc is mounted to the first disc to allow rotational movement of the second disc with respect to first disc about their common centers such that when an alignment arrow on the second disc is positioned in line with the actual age in hours of an infant patient as imprinted on circumferential indicia of the first disc, the treating physician will be provided treatment recommendations for each of the hyperbilirubinemia management stages by comparing the actual serum bilirubin levels for the particular infant patient to the threshold serum bilirubin levels for the age in hours and risk factors.

### BACKGROUND OF THE INVENTION

This invention relates to calendar devices. More specifically, it relates to an hourly calendar device for management of hyperbilirubinemia in newborn infants from the moment of birth.

It is well known that jaundice occurs in newborn infants. Jaundice is a yellowish discoloration of the skin, conjunctiva and mucous membranes caused by hyperbilirubinemia (increased levels of unconjugated bilirubin in the blood). Bilirubin is the product of the heme metabolism (mostly produced when red blood cells die) and normally passes through the liver where it is conjugated and excreted as direct bilirubin through the intestines. When bilirubin builds up faster than a newborn's liver can metabolize it, the equilibrium between production and excretion is altered and jaundice will occur.

While most jaundice is benign, high levels of bilirubin are potentially toxic and can cause a severe form of brain damage known as kernicterus. Because of this terrible potential, it is recommended that newborn infants be monitored to identify those who might develop severe hyperbilirubinemia.

Infants with significant jaundice are normally treated with appropriate levels of a colored (blue-green spectrum) light called phototherapy which breaks down the bilirubin. Phototherapy works by changing the bilirubin into water-soluble isomers that can be excreted in the stools without getting conjugated in the liver.

In certain instances where phototherapy is not successful, it may be necessary to do an exchange transfusion of blood in which the infant's blood is exchanged for normal blood from a donor.

It has also been determined that there are levels of risk depending on the time of gestation, with infants delivered at full term generally considered to be at less risk than those delivered pre-maturely (preterm). However, there are several other recognized risk factors which can change the level of risk. Among these are isoimmune hemolytic disease, G6PD deficiency, asphyxia, significant lethargy, temperature instability, sepsis, or acidosis.

Guidelines for treatment therapies for hyperbilirubinemia in newborn infants by postnatal age in hours based on levels of risk and accompanying risk factors have been published by the American Academy of Pediatrics and are well known to neonatologists. PEDIATRICS Vol. 114 No. 1 Jul. 2004.

While these guidelines are well known, there remains a need for rapid retrieval of the necessary information by the treating physician to correlate postnatal age in hours, risk factors and serum bilirubin levels with appropriate therapies.

### SUMMARY OF THE INVENTION

It is an object of this invention to provide a hyperbilirubinemia management calendar for use by treating physicians and associated caregivers in treatment of hyperbilirubinemia in newborn infants having a first sheet in the form of a circular disc with indicia corresponding to postnatal age in hours and serum levels of bilirubin corresponding to risk levels and risk factors for phototherapy, exchange transfusion and follow up. A second sheet in the form of a circular disc is mounted to the first sheet for relative rotational movement with indicia for risk levels and risk factors pertaining to phototherapy, exchange transfusion and follow up with windows to allow view of serum levels of bilirubin on the first sheet pertaining to a selected postnatal age in hours for a certain risk level and risk factor and either phototherapy, exchange transfusion or follow up.

### BRIEF DESCRIPTION OF THE DRAWINGS

FIG. 1 is a view of the hyperbilirubinemia management calendar as seen from the front.

FIG. 2 is a view of the first sheet of the hyperbilirubinemia management calendar as seen from the front without the second sheet.

FIG. 3 is an enlarged view of the second sheet as seen from the front.

### DETAILED DESCRIPTION OF THE INVENTION

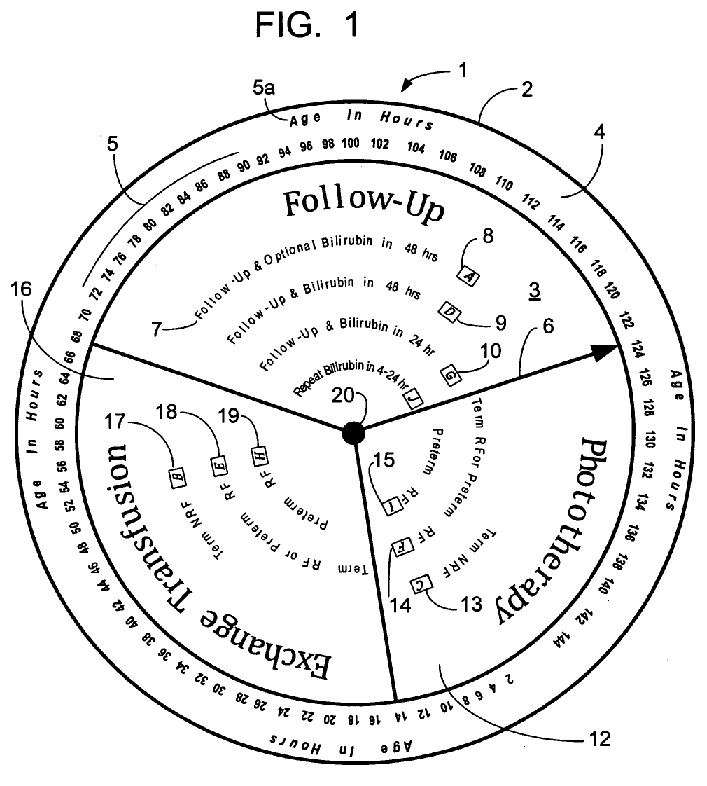

FIG. 1 is a front view of the inventive hyperbilirubinemia management calendar 1 which comprises a first sheet 2 in the form of a circular disc and having a front face 2a and a rear face 2b, upon which is concentrically mounted a second sheet 3 with a front face 3a and a rear face 3b, also in the form of circular disc but having a smaller diameter than the first sheet 2. Second sheet 3 is mounted for rotational movement with respect to first sheet 2 by a fastening device 20 that passes through the centers of both first sheet 2 and second sheet 3. Both first sheet 2 and second sheet 3 would be of a suitable flat material or board such as paper cardboard or sheet plastic suitable for printing and displaying text and numbers.

The outer ring 4 of the front face 2a of first sheet 2 described circumferentially by the space between the outer edge of second sheet 3 and the outer edge of the front face 2a of first sheet 2 is imprinted with circumferential indicia 5 corresponding to the age in hours of an infant. The indicia 5 are appropriately labeled with label 5a. The indicia 5, as shown, represent the age in hours of an infant from 2 to 144 hours in 2 hour increments, with each increment subtending an arc of substantial the same length about the circumference of first sheet 2.

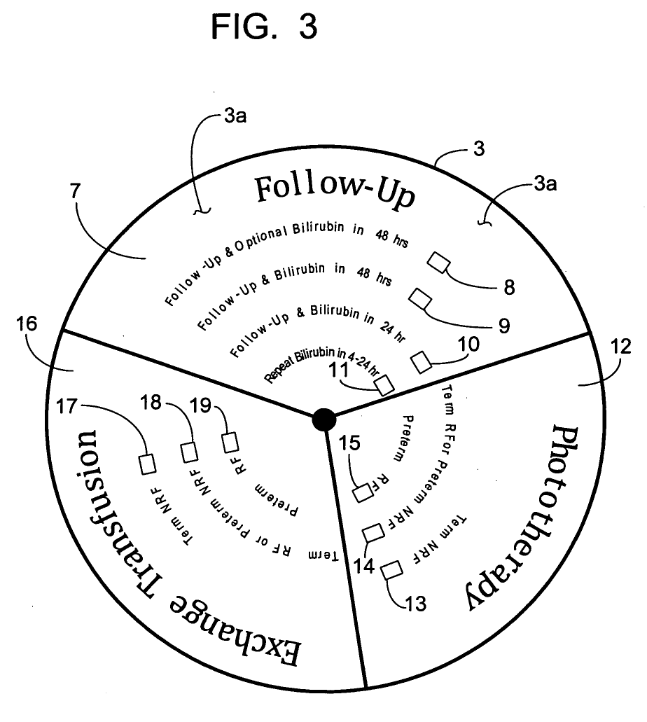

As further seen in FIG. 1 and more fully depicted on FIG. 3, the front face 3a of second sheet 3 is subdivided into three segments or arcs representing stages in management of hyperbilirubinemia and labeled accordingly. There is a phototherapy portion 12, an exchange transfusion portion 16 and a follow-up portion 7. Also shown on the front face 3a of second sheet 3 is an alignment arrow 6 radiating from the fastening device 20 to the circumferential indicia 5 corresponding to the age in hours of an infant as imprinted on the front face 2a of the first sheet 2. The rotation of second sheet 3 with respect to first sheet 2 about their common centers allows the alignment arrow 6 to be placed in line with the actual age in hours of an infant patient as imprinted on circumferential indicia 5 and, as explained below, will afford the treating physician rapid access to treatment recommendations based on the actual serum bilirubin levels for the infant patient.

In each of the phototherapy portion 12, the exchange transfusion portion 16 and the follow-up portion 7 on the front face 3a of second sheet 3 are a plurality of radially disposed labeled windows, each at a different radial distance from the common centers of first sheet 1 and second sheet 2.

In the follow-up portion 7 is a “Follow-Up & Optional Bilirubin in 48 hrs” window 8, a “Follow-Up & Bilirubin in 48 hrs” window 9, a “Follow-Up & Bilirubin in 24 hrs” window 10, and a “Repeat Bilirubin in 4-24 hrs” window 11.

In the phototherapy portion 12 is a “Term NRF (No Risk factor)” window 13, a “Term RF or Preterm NRF” window 14, and a “Preterm RF” window 15.

In the exchange transfusion portion 16 is a “Term NRF” window 17, a “Term RF or Preterm NRF” window 18, and a “Preterm RF” window 19.

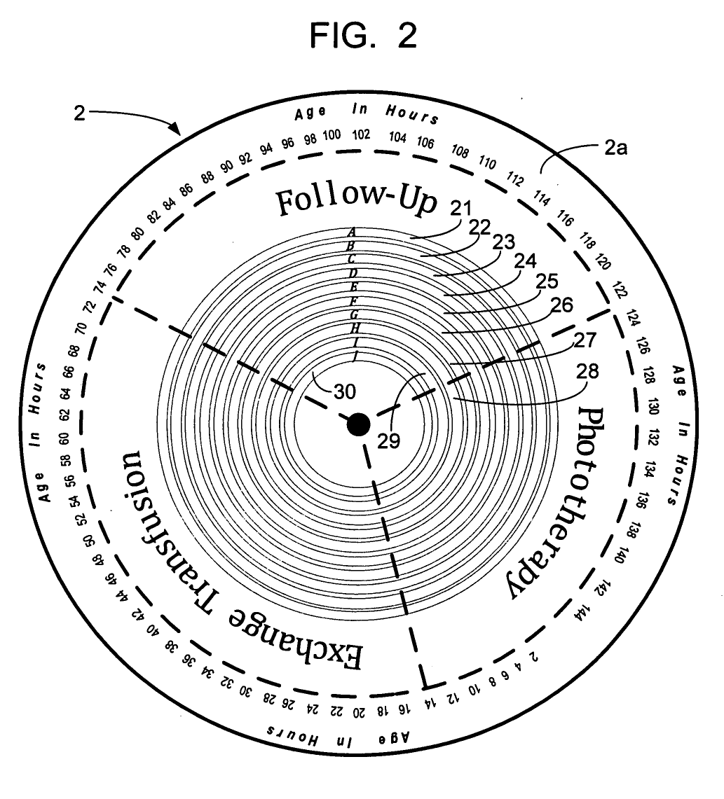

FIG. 2 shows the front face 2a of the first sheet 2 of the hyperbilirubinemia management calendar as seen from the front without the second sheet 3. FIG. 2 depicts a series of annular rings A, B, C, D, E, F, G, H, L and J, respectively numbered 21, 22, 23, 24, 25, 26, 27, 28, 29, and 30. While not shown, it is intended that each of rings 21 through 30 will be circumferentially imprinted with threshold serum bilirubin levels provided under established clinical guidelines for treatment therapies based on risk factors and age in hours. As can be seen from FIG. 2, when the alignment arrow 6 is placed opposite the age in hours shown in circumferential indicia 5, a combination of threshold serum bilirubin levels circumferentially imprinted on rings 21 through 30 will be visible in the appropriate windows 8, 9, 10, 11, 13, 14, 15, 17, 18, and 19 on their respective portions 7, 12 or 16. Based on the age in hours, actual serum bilirubin level and risk factors for a particular patient, the treating physician can make an immediate determination of needed therapies without the need for calculation or reference nomographs.

While not shown, the rear face 2b of first sheet 2 can be imprinted with indicia comprising contact information, disclaimers, labels, logos, citations to the guidelines used as source for threshold serum bilirubin level determinations, and instructions for use of the hyperbilirubinemia management calendar.

It is not intended that the invention be limited to the embodiment described above, and other combinations of therapies, risk factors and age would be in keeping with the spirit and scope of the invention.

I claim:

1. A hyperbilirubinemia management calendar for use by treating physicians and associated caregivers comprising:
a first sheet in the form of a circular disc with a front face and a rear face, imprinted on the front face with circumferential indicia defining age in hours, and further comprising a plurality of annular rings circumferentially imprinted with serum bilirubin levels for treatment therapies based on risk factors and age in hours;
a second sheet in the form of a circular disc with a front face and a rear face mounted for rotational movement about the first sheet with an alignment arrow imprinted on the front face, and further comprising portions pertaining to stages of hyperbilirubinemia management and each of said portions comprising more than one window labeled with risk factors and radially disposed to reveal one or more of the serum bilirubin levels circumferentially imprinted on the annular rings of the first sheet when the alignment arrow of the first sheet is placed opposite an age in hours circumferentially imprinted on the first sheet;
so that a comparison can be made with actual serum bilirubin levels to assist in determination of needed therapies.

2. The hyperbilirubinemia management calendar of claim 1 wherein the first sheet comprises circumferential indicia defining age in hours in hourly intervals; and the portions comprise a follow-up portion, a phototherapy portion, and an exchange transfusion portion; and the windows in the follow-up portion comprise a window labeled “follow-up and optional bilirubin in 48 hrs”, a window labeled “follow-up and bilirubin in 48 hrs”, a window labeled “follow-up and bilirubin in 24 hrs”, and a window labeled “repeat bilirubin in 4-24 hrs”; and the windows in the phototherapy portion comprise a window labeled “term NRF”, a window labeled “term RF or preterm NRF”, and a window labeled “preterm RF”; and the windows in the exchange transfusion portion comprise a window labeled “term NRF”, a window labeled “term RF or preterm NRF”, and a window labeled “preterm RF”.

3. The hyperbilirubinemia management calendar of claim 1 wherein the rear face of the first sheet further comprises imprinted indicia.

4. The hyperbilirubinemia management calendar of claim 3 wherein the imprinted indicia on the rear face of the first sheet comprises contact information, disclaimers, labels, logos, citations to the guidelines used as source for threshold serum bilirubin level determinations, and instructions for use of the hyperbilirubinemia management calendar.

5. The hyperbilirubinemia management calendar of claim 1 wherein the circumferential indicia defining age in hours extends from 2 to 144 hours in 2 hour increments; and wherein the portions are labeled: follow-up, phototherapy and exchange transfusion; and the windows in the follow-up portion comprise a window labeled “follow-up and optional bilirubin in 48 hrs”, a window labeled “follow-up and bilirubin in 48 hrs”, a window labeled “follow-up and bilirubin in 24 hrs”, and a window labeled “repeat bilirubin in 4-24 hrs”; and the windows in the phototherapy portion comprise a window labeled “term NRF”, a window labeled “term RF or preterm NRF”, and a window labeled “preterm RF”; and the windows in the exchange transfusion portion comprise a window labeled “term NRF”, a window labeled “term RF or preterm NRF”, and a window labeled “preterm RF”.
